(19) United States
(12) Patent Application Publication
(10) Pub. No.: US 2011/0253820 A1
(43) Pub. Date: Oct. 20, 2011

(54) CRUSHING SYSTEM WITH TWO ROTATING DISK SECTIONS AND USES THEREOF

(75) Inventor: Ademar Luis Corradi, Mato Grosso (BR)

(73) Assignees: ANTONIO AUGUSTO FELIX DE SOUZA GOMIDE, SAO PAULO (BR); TIAGO ANDRADE DE ALMEIDA, BRASILIA, DF (BR)

(21) Appl. No.: 13/139,247

(22) PCT Filed: Dec. 1, 2009
(86) PCT No.: PCT/BR2009/000442

§ 371 Date: Jul. 11, 2011

(30) Foreign Application Priority Data
Dec. 10, 2008 (BR) PI0805556-4

(51) Int. Cl. B02C 7/00

(52) U.S. Cl. 241/101.2; 241/198.1

(57) ABSTRACT

The present invention relates to a crushing system with two rotating disk sections which allows applying high pressures without the problem of raw material rejection and with a reduced number of crushing cycles, thus shortening the crushing time. Pressure is gradually distributed between the two similar rotating disk sections which are arranged face to face and connected to non-aligned shafts, such that the lower sides of the disk sections remain always joined. The disk section mounting assembly is independent and has different features, forming a fixed part and a movable part for adjusting the vegetable mass being compacted. This crushing system has structural features that allow different uses (in isolation, in tandem or in combination), and the serial combination thereof in appropriate industrial infrastructures or in harvesters of standing crops, such as sugar cane.

### FIELD OF INVENTION

The present invention relates to a crushing system with two sections of similar disks facing each other, which is connected to non-aligned axes so that the lower portions of the discs always remain united during the operation, the discs being kept in rotation thus compressing vegetable material for extraction of juice or liquids thereof. The supporting set from the disc sections is independent and has distinct characteristics, forming a fixed part and a movable part in order to adjust the vegetable mass to be compacted. This crushing system can be used alone or in series on suitable mounting according to necessity.

Another aspect of the present invention is related to the application thereof in the process of obtaining vegetable liquid, more specifically of sugar cane. In this case, the proposed crushing system also may be engaged in harvesting of sugar cane, being a part of such agricultural machinery either as one or as a series of such crushing units.

Thus, the technical field of this invention belongs to sugar cane and other biomass crushing and to the mechanical extraction of liquids from biomass. This aspect of agricultural technology is of interest for sugar and alcohol industries and industries manufacturing agricultural machinery or the like.

### STATE OF THE ART

Processors for vegetable mass including crushing systems, specifically for sugar cane, correspond to a mechanical equipment usually based on the use of horizontal metal roller system which, when fed, crush the stems of plants by compression, extracting broth or liquid. Industrially, the systems are operated cylinders or rolls, alone or in series, as is the case of the milling process of sugar cane presented in the patent application PI0201995-7, where the pulp is directed to pass through a series of successively cylindrical mills (the mass generated in a first one feeding the next, thus completing cycles). Patent application U.S. Pat. No. 4,147,557 also discloses systems of plural coils in series. In said technological line, there are also examples of the use of cylindrical roller mills as disclosed in documents BRPI9305112-3 and BRPI07007221.

Most of the portable versions of mills for sugar cane are also based on the use of cylinders or rolls such as, for example, the model described in document BRMU7500595-6.

Another process of sugar cane crushing, although less common, is the one using a “worm” to press and crushing plants. Typically, this type of system uses a screw press cone (BRPI0303941-2), including the use conical rings at their ends, as shown in the patent application GB1375497.

The main limitations of grinding systems for vegetables with relative resistance, such as sugar cane, relate to the control of the pressing force regarding the initial characteristics of the vegetable mass input, especially for whole stalks or pieces of cane, including shredded sugar cane (bagasse). The feeding system for grinding rolls in this commodity, under conditions of high pressure in order to increase the efficiency of extraction of the liquid, leads to serious technological problems caused by the rejection of material or considerable loss of vegetable mass entering the system. The vast majority of patents related to roller systems seek to solve this problem, usually by adjusting the milling process, starting with little pressure and adjusting the compression as the bagasse is compressed (shredded cane). In this case, the milling process occurs in cycles, and so as to increase the extraction of sucrose, the bagasse must be wet (additional clean water) between each grinding cycle. This process becomes expensive, since it uses large amounts of water, besides being a lengthy process. To reduce the time spent in these extraction processes there have been proposed several types of arrangements between the cylinders in series (usually by three roller units—milling suits). However, the step of wet bagasse generated is still required for the grinding operation of the said invention, especially in industrial processes, to ensure the extraction of sucrose by repeated cycles of pressing resulting, in the end, in the formation of bagasse with an average of 50% humidity. However, there are less cycles, due to high extraction efficiency of liquid (lesser grinding time).

Some attempts to solve the problem of the rejection of the raw material in the grinding rolls are based on the introduction of a fourth roll, usually of smaller diameter and/or association between milling suits and/or introduction of sugarcane expansion prior to pressing, as described in the patent application BRPI0503537-6. The introduction of the grinding stage after cutting the cane into small pieces is also explored technologically. The selection of raw material is also used so as to increase concentration of sucrose during operation, either by use of more productive and resistant plants or by harvesting procedures, which despise the tip of the cane still in the field, such as the lateral cutting device used in sugar cane harvester machines described in the patent application BRPI0402356-0.

Another disadvantage of systems with horizontal rollers is linked to the high occurrence of idle mill, and for this reason, serial sets of rolls are being increasingly exploited, since they have smaller spacing between rolls wherein the installation of recirculation systems of bagasse is usually performed with the use of rotary mats. The patent application BRPI0201995-7 describes a process and a plant for grinding sugar cane with these characteristics in order to minimize the idle time of milling. Other embodiments are listed, as described in document BRPI0700722-1, referring to the mill for sugar cane and other biomass and consisting of a central roller surrounded by several others.

For the case of systems based on the use of “worm”, the main limitations of applying these systems, especially in the case of sugar cane, resides in the low extraction efficiency of liquids, although it can achieve high compression of biomass. Typically, these systems have a slower extraction process and require high-energy expenditure. Their implementation on an industrial scale is also impaired because they require an elaborate extraction chamber.

The present invention is based on the crushing by discs, more specifically on the use of sections of convex discs in rotation, operating so that the lower portions of the discs are always united, wherein the adjustment of the vegetable mass is to be controlled by means of compressed springs or a piston that pushes one of said portions of discs, preferably the one which has an inclined supporting axis. The layout of this system allows the use of high compression without the rejection of the raw material, especially the initial (pieces of cane) and defibered sugar cane, and consequently, a higher extraction efficiency of liquids. This crushing system is innovative, since the vast majority of the implementation of discs or rotating disc sections in the beneficiation process of sugar cane, usually relates to constructive aspects of cutters and/or cleaning and/or scrapers for sugar cane and also in maintenance processes in the farming moan systems, as discussed in several patent applications.

The grinding step established by this sections of convex discs system is similar to that already established in the art, wherein sugar cane is harvested, cleaned, cut into pieces and then taken to grind. As the crushing process can be considered the end of the agricultural process and the beginning of the industrial process, it becomes important to develop systems that are faster and have more efficient grinding, since the substance of interest present in the liquid extracted from the crushing, i.e. sucrose, has reaction pathways that lead the consumption thereof, undermining the amount obtained in the extraction process. In the living plant, said substance reaches a maximum over time, which then undergoes a decline, mainly due to polymerization reactions of sucrose, leading to the formation of cellulose (structure found in bagasse). This relates to the natural maturation and drying of the plant. To minimize losses, the cane is harvested when it has its maximum sucrose content and should be crushed immediately. In this sense, crop harvesters are being provided with vertical grinding systems. The vast majority of proposed grinding units, alone or in series, coupled with this type of harvesting is based on the use of cylindrical rollers. This is the case of patent documents BRPI9204012 and BRPI9704191-2-8 that allow direct extraction of the liquid in the farming.

Regardless of the provision of constructive grinding systems in harvesters, the abovementioned patents, related to the subject matter herein described, do describe the process of extracting the liquid from the cane comprising the steps of cutting, feeding, grinding and milling. In the cutting step, the sugar cane plantation is harvested, in the feeding step the cut cane is carried into the machine, in the grinding stage the cut cane is delivered and crushed into small pieces, in the milling step the cut cane is pressed and crushed several times, so as to allow the juice to be extracted from sugar cane. All propositions are based on increasing the efficiency of extraction. To get an idea of the importance of the crushing system in the production process, one should consider a plant producing 1 million gallons of alcohol per day, with deficiencies in milling that lead to a loss of 1% in the efficiency of extraction of liquids. This means a loss of 10,000 gallons/day of sugar cane juice, material that is no longer introduced into the production system.

The crushing system based on sections of convex discs, object of the present invention, provides different possibilities for applications and use as milling units in different ways, alone or in pairs or combined or as separate series (serial combination of individual units, in pairs or combined) in suitable mounting or coupled to the harvesters of vertical crops, mainly sugar cane. The main advantage of these systems is the possibility of working with high compression with low power consumption and the fact that it has a constructive structure lighter than those based on grinding by roller systems or “worm”, allowing the extraction of sucrose more efficiently in shorter amounts of time, virtually with no formation of excess capacity and no rejection in the milling of raw materials, i.e. mainly pieces of shredded sugar cane and sugar cane (bagasse). Moreover, these systems have low wear of grinding, since they do not work on friction. During operation, only the lower parts of the sections of the discs are assembled, allowing the use of a seal between them.

These advantages are important for implementation on harvesters. The milling of sugar cane farming, besides allowing better utilization of sucrose present in the plant, reduces risk of contamination of the broth, the reduction in the time of handling and in storage. In this case, the grinding also occurs in cycles, requiring a wet bagasse between one grinding cycle and the other, but with great reduction in the number of cycles. Since such a system presents no problems of rejection, especially with pieces of sugar cane, cane tips that are normally discarded during the cutting thereof, due to its low concentration of sucrose, may be used for grinding to obtain water to wet the mulch during milling cycles, helping to reduce water consumption during the production process, which is a trend imposed by the rational use of natural resources.

Another important factor is getting the bagasse crushed more quickly, said bagasse being in condition of becoming raw material for the production of biofuels such as ethanol or ethanol from lignocellulose, by the use of specific enzymes in addition to its traditional use in providing heat for boilers (by the burning thereof).

### DESCRIPTION OF THE INVENTION

The present invention relates to the development of a crushing system by means of the compression of two sections of rotating discs. The compression is gradually distributed between the two sections of similar disks arranged frontally and connected to non-alligned axes, so that the lower portions of the discs always remain united during the operation or rotation. The supporting set of the sections of the disc is independent and has distinct characteristics, forming a fixed part and a movable part in order to adjust the vegetable mass to be compacted. This crushing system has structural features that allow its use in different forms: single, in pairs, or as an ensemble, enabling its use in series in suitable mounting in power plants or vertical crop harvesters such as sugar cane.

The surface of the two sections of discs allows different settings to increase the extraction efficiency depending on the raw material and/or the state thereof. For example, surfaces smooth or with soft waves or with small cutters are preferred for cane or pieces of cane, while surfaces with more structured mills are preferred for grinding the shredded cane (bagasse).

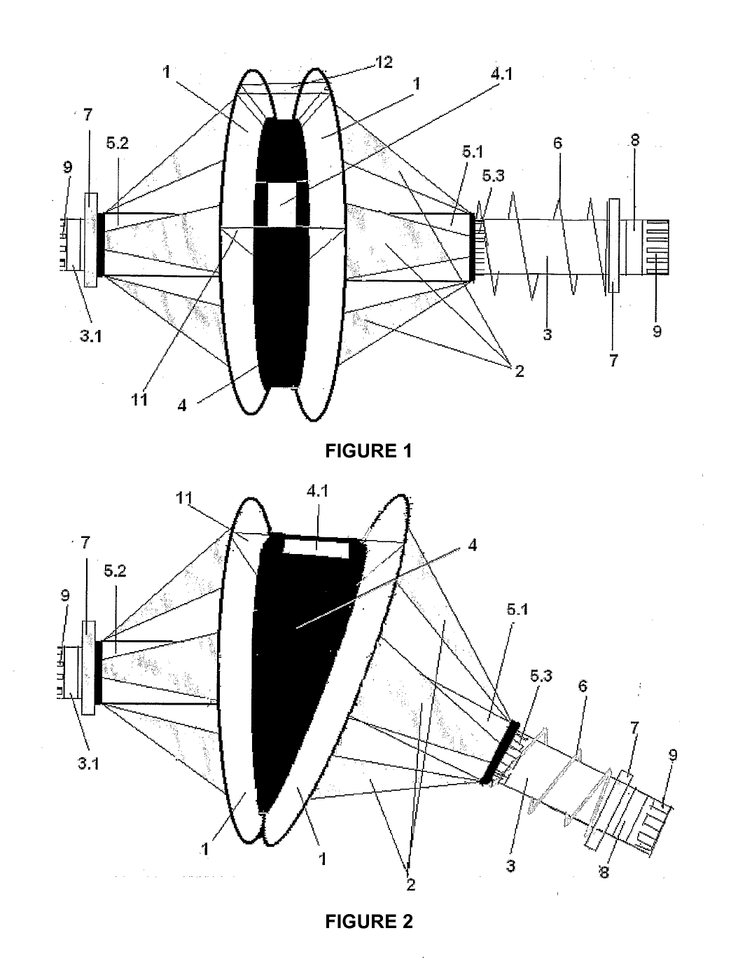

The invention may be better understood by means of the following detailed description of FIGS. 1-9, provided for illustration only and without restricting the object of the present invention regarding color, size and/or material used in the manufacture thereof. These figures show similar constructive mechanisms for different forms: isolated with only an inclined axis, isolated with both axes inclined, in pair and combined, resulting in four embodiments for grinding systems with the same inventive concept, respectively described in Examples 1 to 4.

FIG. 1 shows a top view of the crushing system with two sections of convex discs with only one inclined axis.

FIG. 2 shows a front view of the side of the crushing system with two sections of convex discs with only one inclined axis.

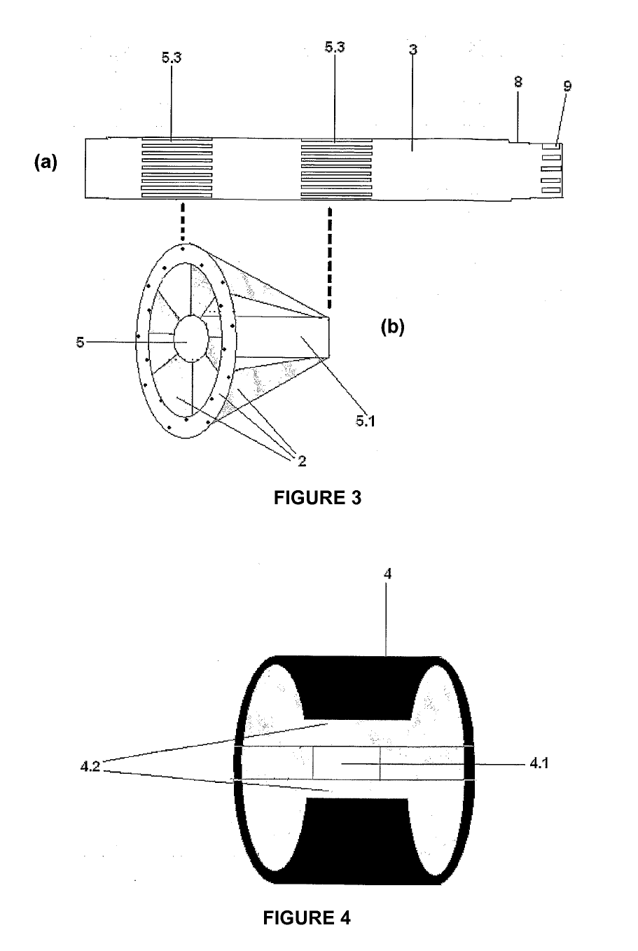

FIG. 3 shows: a) a perspective view of the lateral axis inclined support section of the disc (3) and b) a perspective view of support to sustain the disc convex section.

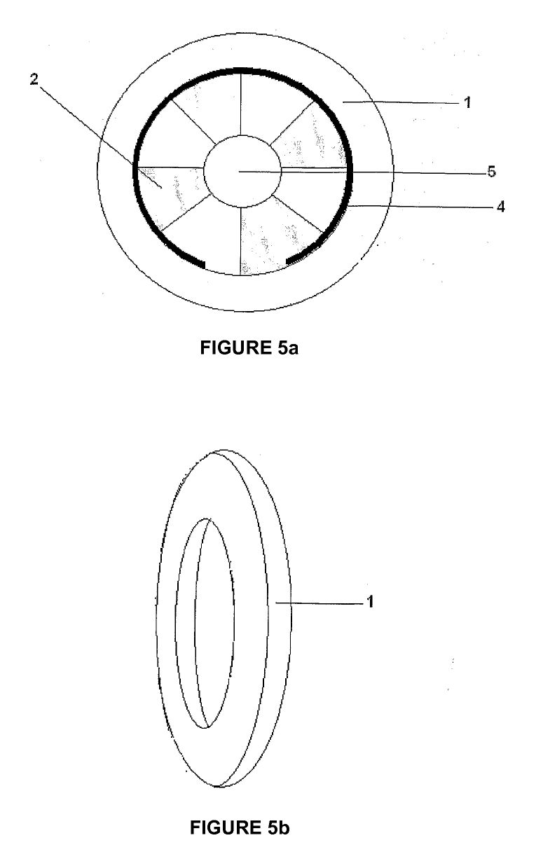

FIG. 4 shows a bottom view (from below) of the retainer (4) used between the two sections of convex discs with only one inclined axis, pointing out cavities thereof ((4.1) and (4.2)).

FIG. 5 presents: a) a front view section of the convex disc on the support bracket, and b) a perspective view of the convex disc section.

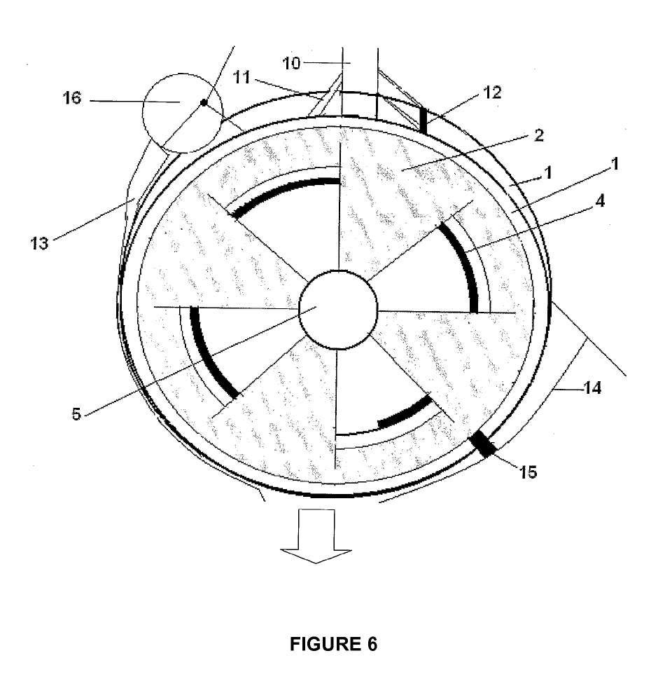

FIG. 6 shows a side perspective view of the crushing system with two sections of convex discs with the inclusion of other constituents, such as retractable feeder (16), support of the central axis (10) and housing structures or structural coverage ((13) and (14)), wherein the grinding set is inserted. The large arrow indicates the transition for the flow of the liquid obtained by grinding.

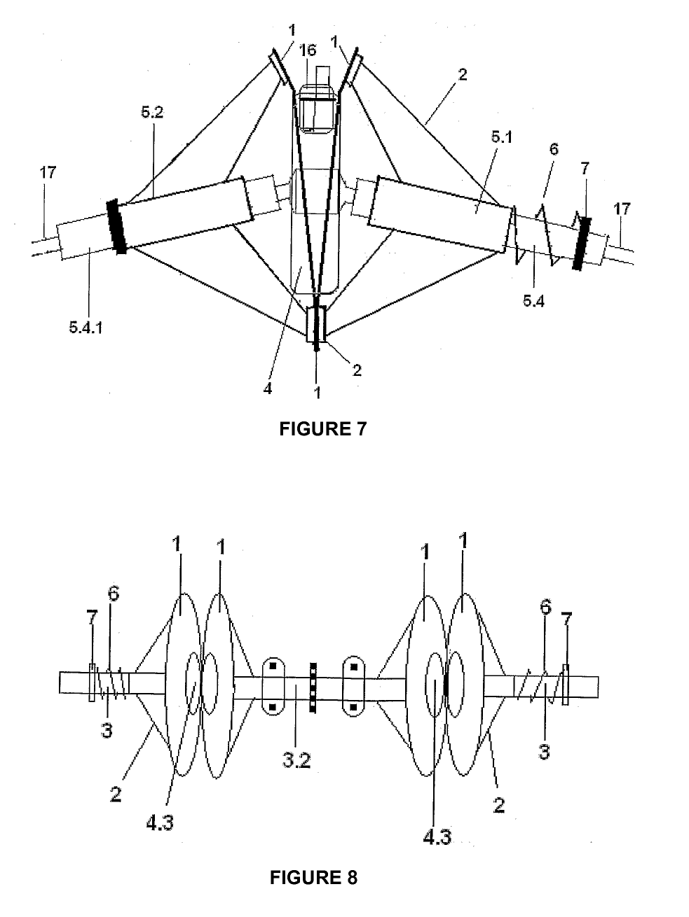

FIG. 7 shows a front view of the side of the crushing system with two sections of convex discs with both axes inclined.

FIG. 8 shows a top view (top to bottom) in the dual system of grinding having two sections of convex discs with at least one inclined axis for each pair of sections of discs.

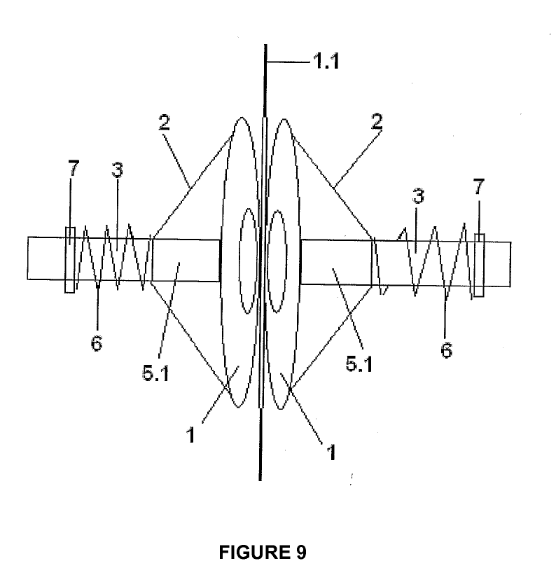

FIG. 9 shows a top view (top down) of the combined system with three sections of grinding discs with inclined axes, the section of middle disc being differential (1.1).

The design of grinding systems of the present invention depends on the demand of production volume, varying in size so as to fit more simply in family units, up to its use in industrial plants as well as its solo use or in association sets (in series), in support systems near alcohol plants or harvesting machinery for sugar cane.

### EXAMPLE 1

This example refers to an embodiment for a crushing system with compression having two sections of the rotating discs with just one inclined axis, mainly used for grinding sugar cane. This inclined axis rotation allows for the lower parts of sections of disc to always stay together, thus allowing the work with high compression with no rejection of raw material.

FIG. 1 shows a general outline of the abovementioned system with its key constituents: sections of convex discs (1); support to sustain the convex disc section (2); inclined axis support bracket section of the disk (3); fixed axes support section support disk (3.1); inner seal (4) arranged between the sections of the discs, featuring two separate chambers, an upper one (4.1) for fitting the support bracket axes (10) (shown in FIG. 6) and another larger one along the whole length of the retainer (4.2), prepared in the region of union between the two sections of disks (hidden in this picture); inclined (5.1) and fixed (5.2) shaft sleeves, indicating their cutters (5.3) mainly between the sleeve shaft and axes; compression actuator (6), represented by springs in this figure. The specific locks (7), the rotation elements (8) and points of tension (9), depend on the type of compression actuator used. Other accessories are provided to complete the crushing system, such as bagasse cleaner (12), retractable feeder (16) and structures for housing or structural coverage or housing ((13) and (14)), which involves the system as a whole, assisting the direction of feeding flow and the liquid extracted by means of constructive units as the feeding director (11), bottom opening (indicated by large arrow in FIG. 6) and retention of residual elements of pulp and liquid present in sections of the rotating disk (15).

In the present invention, the two sections of convex discs (1) will compress the raw material into a rotary motion in which both sides of the disks will meet each other guided by two axes where at least one of them, is inclined relative the horizontal plane (as shown in FIG. 2, which is a front view of the side of the scheme shown in FIG. 1). The two axes refer to the inclined axis of support to sustain the section disk (3) and fixed to the axes support bracket section of the disk (3.1). These axes comprise two sets of support from sections of independent disks, with a fixed part (part supported by the shaft (3.1)) and a mobile part (part supported by the shaft (3)) that contains the compression actuator (6) of section disk (1). This actuator is represented by springs, piston among other, that are motor-driven and fixed to the shaft by specific locking (7) by means of rotation elements (8) (e.g., bearings) and traction points (9), which should be connected to the rest of the structure of grinding. In general, the axis of the movable part (3) is greater than the axis of the fixed part (3.1), and the rotation is made possible by the use of sleeves of the inclined (5.1) and fixed (5.2) axes. The compression system is strong and has the support bracket of the disc sections (2) (detail in FIG. 3b). The compression operation is performed by forceful compression of the disk sections actuator (6), herein represented by springs. The whole of the movable part moves with the aid of milling (5.3) between the sleeve shaft and axes, especially between (5.1) and (3) (detailed in FIG. 3.a).

In the specific case of sugar cane the feeding of the process is necessarily made between the disc sections (1), thus lacking rejection since the stems are trapped and increasingly pressured by the gradual meeting of the chambers of the disc, drawing the fibers and extracting the juice. The sections of the discs work with the same rotation, supported by an internal repair or retainer (4) function thereof being to ensure that the raw material moves through the sections of discs. This retainer has two openings; a small upper opening (4.1) where the stand fits the support axis of the fixed and mobile parts ((3) and (3.1)) and one large opening on the lower portion (4.2), close to the union between the lower sections of the disk, wherein the liquid drains from the system (detailed in FIG. 4). The retainer (4) is not compressed by the disc sections during the grinding. This crushing system also includes a feeding driver (11) and a pulp cleaner (12) (these and other accessories are described in FIG. 6).

FIG. 3.a shows a schematic of the inclined shaft support of the disc section (3) highlighting the cutters (5.3) that allow the displacement of the moving part of this crushing system by compression. Dotted lines highlight the close fit between the central opening (5) of the support bracket (2) with the edge of the inclined shaft sleeve (5.1). In the scheme of FIG. 3b, it can be noted that the support to sustain the convex disc section (2) is a sole piece, sustaining: i) the full length of part of the disc, with the possibility of using screws to secure it; ii) the radial part of the sections of the disk (center defined by the opening of the central support bracket (5)), iii) the outer section of the disc that extends to the end of the sleeve shaft (5.1). This support bracket (2) presents the possibility of having different configurations, with side-piece (closed system), streaked media, among others, maintaining the same purpose.

FIG. 4 shows a scheme with a view from below of the retainer (4) used between the two sections of convex discs. In this scheme, it can be noted that the width of the top, which contains a small opening or cavity (4.1) is higher than the bottomthereof, which has a complete opening of the retainer (4.2). This difference in top and bottom widths is related to the position of the compression system between the disc sections, where the bottoms are always united and the top is open. The retainer (4) is embedded between the disc sections (1), fair and well maintained, for example with the aid of sealing materials such as rubber. In this system of grinding, the retainer is fixed (does not turn with the sections of convex disks).

FIGS. 5.a and 5.b show a schematic illustration of the convex disc section (1) used in the crushing system proposed, showing part of the support bracket (2), with its central opening (5), where the sleeves axis ((5.1) or (5.2)) is fixed, indicating also the retainer with its lower opening (4). The sections of the disk being used are quite resistant to compression, preferably formed of structural metal material such as stainless steel, iron alloys and steel alloys, or diverse structural polymeric material (resistant plastics), among others.

The surfaces of the sections of the mill drives have settings dependent on the raw material and/or state thereof (pieces of cane or shredded cane/bagasse), allowing the use of sections of convex disks with smooth surfaces and/or milled and/or corrugated. These variations are presented to increase the liquid extraction efficiency. Preferably, in the case of sugar cane in its natural state (pieces of cane), the two disks must have gentle undulations to force even more power and at the same time giving vent to the broth as far back as the sides. As for the case of shredded cane, as a second mill, wherein the fibers are embedded in liquid—usually water—the disc should have milling (lengthwise and parallel to the perimeter of the disks) to help force the return of the liquid at high pressure among the fibers to draw more sucrose. In both states of the raw material, the liquid cannot find passage at the maximum peak pressure point of the discs.

FIG. 6 shows a schematic illustration of the crushing system with two sections of convex discs with the inclusion of other constituents to complete the proposed crushing system with compression of two sections of the rotating discs with only one inclined axis (the constituents were described in FIGS. 1 and 2).

The operation of the crushing by compression of the two sections of convex disks in rotation (1) has at least one of the axes inclined (to allow closure only at the bottom), but with both in the same plane. The compression is forced by the moving part, comprising the inclined shaft (3), getting power by any of the hydraulic, mechanical or electrical means, with compression being determined by the piston, springs and the like. It is based on two sections of convex disks that are alike (1), working in rotation, stuck to their respective support (2) of the fixed and movable part, which in turn are coupled to their corresponding axes (axes (3.1) and (3), respectively). Both axes are fixed, only the support of one of the axes is mobile, which suffers the action of an actuator compression (e.g., springs) that are meant to push the support section of the inclined disc and therefore push the disc sections against each other, both in rotation, determining the necessary compression to crush the material. The movement of the inclined shaft (3) to support (2) is made by longitudinal milling (5.3) present within the support shaft and the external part thereof. Both discs work with the same rotation, supported by an internal retainer (4) which serves to ensure that the raw material moving through the disc sections, during compression. The entire assembly mounted between the two shafts must be inserted into casing structures or structural coverage or housing ((13) and (14)). This envelope has the function of assisting the direction of the feeding stream and of the extracted fluid, and avoids direct contact with the mill, providing operational safety, and also helping to reduce the contamination of the liquid obtained. The retaining element (15) is an external repair of the mill, with the function of retaining the residual liquid on the outside of the chambers of the discs before they open.

The crushing system based on compression between two disc sections also provides other minor components such as pulp cleaner (12), retractable feeder (16) and feeding driver (11).

The feeding director (11) is attached to the support bracket between the axes (10), constituting a structure inclined to direct and continued feeding and for separating the feeding vegetable matter from the output of bagasse. Moreover, it prevents the plant material from being deposited into the support bracket (10). This driver is positioned frontally to the feeder (16), preferably being made of resistant flexible material (e.g. rubber) for pieces of cane, and metallic structural material (e.g. metal—such as iron, metal alloys, like steel, among others) for shredded sugarcane bagasse.

The pulp cleaner (12), known in the art, has the function of cleaning disc sections, extracting the pulp of the overall grinding system. This cleanser is fixed and attached to the support bracket between the axes (10), forming small bar arranged perpendicular to the sections of the rotating discs and placed opposite the feed assembly ((1) and (6)).

The retractable feeder (16), known in the art, is attached to the housing structure or structural coverage (13), consisting of a shaft that supports fixed structural elements (such as blades, caps, forks, etc.), protected by rotary wrappers that expose these structural elements only during the compression of raw material into the mill.

### EXAMPLE 2

This example refers to an embodiment for a crushing system with compression having two sections of the rotating discs with both axes inclined, mainly used for grinding sugar cane, as shown in FIG. 7.

Both the structural constitution and functioning of this system are the same as shown in FIGS. 1 and 2, maintaining the support brackets of disc sections (2) the formation of a fixed and a movable part, driven by the actuator compression (6) (represented by springs), allowing rotation of the disc sections (1) always joined at the bottom thereof. The difference herein is in the main shaft (17), which becomes a single piece with favorable slope (functioning as the inclined axis (3) and fixed horizontal axis (3.1)). In this case, the retainer (4) used between the discs is symmetric (wherein the top is not wider than the bottom), provides no cavities and rotates along with disc sections (2). The sliding of parts supporting the disc sections is made possible by means of sets of sleeves of the mobile parts ((5.1) and (5.4)) and the fixed part ((5.2) and (5.4.1)). The difference between the sleeves (5.4) and (5.4.1) is the length thereof, the one of the moving part being usually higher.

Other accessories are provided to complete this grinding system, such as pulp cleaner (12), retractable feeder (16) and housing structures or structural coverage ((13) and (14)), which involves the whole system, helping the direction of feeding flow and the liquid extracted by means of constructive units.

### EXAMPLE 3

This example refers to a proposal for a dual system of crushing by compression having two sections of the rotating discs with inclined axes, which is mainly used to grind sugar cane as shown in FIG. 8.

In this example, the two sections of internal discs are fixed on the same route, called the inner shaft (3.2), while the other two external drives sitt on two axes inclined to the horizontal plane of the inner shaft (3).

The structural constitution and functioning of this system are the same as shown in FIGS. 1 and 2, maintaining the support brackets of sections of disc (2) the formation of a fixed and a movable part, driven by the actuator compression (6) (represented by springs), allowing rotation of the disc sections (1) always joined at the bottom thereof. The difference herein is in the inner shaft of the dual system (3.2), containing the mounting of internal disc sections that function as the fixed parts of both mills, while the outer and inclined shafts (3) support the moving parts. In this example, the retainer (4) has the same characteristics described for Example 1, providing specific cavities (to engage the support bracket (4.1) and the flow of the liquid obtained (4.2) and should be built between the sections of convex discs inside the cavity to fit the retainer (4.3).

In the milling process, the bagasse generated in one system is later wet and directed to pass through another mill, and so on, for being used in its isolated form or by feeding the next set of double milling in the case of a serial form.

### EXAMPLE 4

This example refers to an embodiment for a crushing system combined with compression of three sections of the rotating discs with inclined axes (double crushing system simplified or reduced), mainly used for grinding sugar cane, as shown in FIG. 9.

The structural constitution and functioning of this system are the same as shown in FIGS. 1 and 2, keeping the mounting support sections of the disk (2) to form a fixed part and a movable part, driven by the actuator compression (6) (represented by springs), allowing rotation of the disc sections (1) always joined at the bottom. The difference herein is that the fixed part is formed by a differencing disc section (1.1), which has two convex surfaces. This differentiated disc has a separator between the two sets of grinding, requiring a structural extension of that disc section to separate the feeding and bagasse generated in one side of the mill from one another. This extension need not present convex faces, as in sections of the discs for grinding and must not be of the same material, just needing to provide mechanical strength (e.g., structural plastic or metallic materials such as metals and alloys).

In the milling process, the bagasse generated in one system is later wet and directed to pass through another mill, and so on, for being used in its isolated form or by feeding the next set of double milling in the case of a serial form. Also, there is provided the use of a combination between the disc sections attached to the compression fit therebetween formed by a convex section with a concave disc, having also variant surfaces (smooth, undulating, milled, and other structural millers among others).

The grinding systems presented in the present invention and described in Examples 1-4 can be used in manufacturing plant harvesters with light harvester for harvesting and milling plants combined in the same equipment, not being restricted to the harvesting and milling of sugar cane, since it can be applied to any vegetable or grain of interest, such as corn, soybeans, among others.

1. A crushing system based on discs for extracting liquids from plants, comprising:
two disc sections in rotation with their lower portions always together or united, supported by brackets for disc sections, mounted over independent axes to form a fixed part and a movable part, by means of the concomitant use of a fixed axis horizontal support bracket disc section and an inclined axis of the support bracket of the disc section, properly structured to allow the fitting of sleeves on the inclined shaft and fixed shaft, allowing displacement by mills, having a compression actuator on the mobile portion, represented by a spring or hydraulic piston, suitably motor driven, completing the moving part by the use of specific locks, rotation elements and traction points, and also used an internal fixed retainer embedded between the sections of the discs, with top wider than the bottom thereof, providing two distinct cavities, an upper one for fitting the support bracket axes and a larger one along the entire length of the retainer, located in the region of union between the two disc sections.

2. The crushing system according to claim 1, wherein the sections of the grinding disc have equal convex surfaces, selected from smooth surfaces, corrugated, with minor structural mills and cutters.

3. The crushing system according to claim 1, further comprising at least one accessory component such as feeding driver, pulp cleaner, retractable feeder and housing structures or structural coverage or housing, which involves the system as a whole, assisting the direction of feeding flow and fluid extracted through construction units, having a lower opening for the exit of fluid and residual retention elements of pulp and liquid present in sections of the rotating disc.

4. The crushing system according to claim 1, further comprising fixed and mobile parts of the brackets for the disc section in rotation with both inclined axes, made possible by the use of a single main axis with a slope suited to replace the inclined axes and fixed horizontal axis, wherein sliding between the fixed and mobile parts is made possible by sets of sleeves of the movable part and fixed part, with compression provided by actuators on the moving part, and the actuator used between disc sections to be symmetrical, having no cavities and rotating together with the disc sections.

5. The crushing system according to claim 4, further comprising at least one accessory component such as feeding driver, pulp cleaner, retractable feeder and housing structures or structural coverage or housing, which involves the system as a whole, assisting the direction of feeding flow and the liquid extracted by means of constructive units, having a lower opening for the exit of fluid and residual retention elements of bagasse and liquid present in sections of the rotating disc.

6. The crushing system according to claim 1, further comprising the formation of a dual system of milling, the association of two pairs of sections of the rotating discs so aligned, with both fixed parts of the system formed by the support brackets of sections of internal discs supported on the horizontal axis of the inner dual system, instead of isolated fixed horizontal axis with both sides moving backed by appropriate external and inclined shafts, being brought about by the compression actuators in these moving parts and using a fixed retainer for each mill, with specific cavities to engage the support bracket and for the flow of the liquid obtained, being embedded inside the cavity.

7. The crushing system according to claim 6, further comprising at least one accessory component for each milling unit, such as a feeding driver, pulp cleaner, retractable feeder and structures or structural coverage casing or housing, which involves the system as a whole, assisting the direction of the feed stream and liquid extracted by means of constructive units, having a lower opening for the liquid outlet and retention elements of residual liquid present in the pulp and sections of the rotating disc.

8. The crushing system according to claim 1, further comprising the formation of a conjugated system of grinding by the association of three sections of discs so aligned in rotation and the two similar sections of external discs and different internal disc section, having grinding surfaces on both sides and a structural extension, increasing its diameter to contribute to the separation of the two independent mills, and the fixed section consisting of the inner disk and the proper support thereof, and both moving parts, arranged externally, consisting of the corresponding external inclined axes, the compression being provided by actuators and using a fixed retainer fitted between disc sections for each mill.

9. The crushing system according to claim 8, further comprising at least one accessory component for each milling unit, such as feeding driver, pulp cleaner, retractable feeder and structures of casing or housing or structural coverage, which involves whole system as a whole, assisting the direction of the feed stream and liquid extracted by means of constructive units, having a lower opening for the exit of the liquid and residual retention elements of bagasse and liquid present in sections of the rotating disc.

10. The crushing system according claim 1, further comprising a combination between the sections of the grinding disks, formed by the fit between a convex section with a concave disc, having equal areas, selected from smooth areas, wavy, with small cutters and structural mills.

11. A method of using a crushing system according to claim 1, wherein the crushing system is used alone or in series, placed in a suitable plants or in harvesting of vertical crops, mainly sugar cane.

12. A system of vegetable grinding and harvesting based on the compression of two disc sections using the crushing system of claim 1.
